(19) United States
(12) Patent Application Publication
(10) Pub. No.: US 2014/0103731 A1
(43) Pub. Date: Apr. 17, 2014

(54) CONTACTLESS POWER SUPPLY SYSTEM AND POWER RECEPTION DEVICE

(71) Applicant: PANASONIC CORPORATION, Osaka (JP)

(72) Inventors: Kaoru FURUKAWA, Osaka (JP); Tomohiro OTA, Hyogo (JP); Kiyoshi OGASAWARA, Osaka (JP); Toshihiro AKIYAMA, Osaka (JP)

(73) Assignee: PANASONIC CORPORATION, Osaka (JP)

(21) Appl. No.: 13/650,231

(22) Filed: Oct. 12, 2012

(51) Int. Cl. H01F 38/14

(52) U.S. Cl. CPC H01F 38/14
USPC 307/104

(57) ABSTRACT

A contactless power supply system is provided with an electric appliance, which includes a secondary coil of a power reception device, and a contactless power supply device including a setting surface, which is formed by a plurality of adjacent power supply areas, and a primary coil, which is arranged in each power supply area. The contactless power supply device excites the primary coil to supply secondary power to the secondary coil of the electric appliance that is set on the setting surface. The secondary coil has a larger coil contour than the primary coil.

### TECHNICAL FIELD

The present invention relates to a contactless power supply system and a power reception device.

### BACKGROUND ART

Various types of electromagnetic induction contactless power supply systems have recently been proposed (e.g., Japanese Laid-Open Patent Publication No. 2011-109810). An electric appliance including a power reception device is set on a setting surface of a contactless power supply device and supplied with power in a contactless manner implementing electromagnetic induction. In this state, a primary coil of the contactless power supply device is excited, and a secondary coil arranged in the power reception device is excited by electromagnetic induction. The secondary coil generates secondary power that is converted to DC power in the power reception device. The DC power is supplied to a load in the electric device.

### SUMMARY OF THE INVENTION

It is an object of the present invention to provide a contactless power supply system and a power reception device in which a secondary coil of a power reception device can receive power with high efficiency from a plurality of adjacent primary coils.

One aspect of the present invention is a contactless power supply system provided with an electric appliance, which includes a secondary coil of a power reception device, and a contactless power supply device including a setting surface, which is formed by a plurality of adjacent power supply areas, and a primary coil, which is arranged in each power supply area. The contactless power supply device excites the primary coil to supply secondary power to the secondary coil of the electric appliance that is set on the setting surface. The secondary coil has a larger coil contour than the primary coil.

Preferably, the coil contour of the secondary coil is 1.25 times or larger and 1.7 times or smaller than the coil contour of the primary coil.

Preferably, the coil contour of the secondary coil is 1.3 times or larger and 1.45 times or smaller than the coil contour of the primary coil.

Preferably, the coil contour of the secondary coil is 1.4 times larger than the coil contour of the primary coil.

Preferably, each primary coil is tetragonal and shaped in conformance with the corresponding power supply area, and the secondary coil is tetragonal and similar to the coil contour of the primary coil.

Preferably, the primary coil and the secondary coil are each wound around a magnetic body.

The present invention provides a power reception device arranged in an electric appliance and used with a contactless power supply device including a setting surface, which is formed by a plurality of adjacent power supply areas, and a primary coil, which is arranged in each power supply area. The power reception device includes a secondary coil that receives secondary power from the primary coil that is excited. The secondary coil has a larger coil contour than the primary coil.

Preferably, the coil contour of the secondary coil is 1.25 times or larger and 1.7 times or smaller than the coil contour of the primary coil.

Preferably, the coil contour of the secondary coil is 1.3 times or larger and 1.45 times or smaller than the coil contour of the primary coil.

Preferably, the coil contour of the secondary coil is 1.4 times larger than the coil contour of the primary coil.

Preferably, the secondary coil is tetragonal and similar to the coil contour of the primary coil.

Preferably, the primary coil and the secondary coil are each wound around a magnetic body.

Other aspects and advantages of the present invention will become apparent from the following description, taken in conjunction with the accompanying drawings, showing by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a contactless power supply device and an electric appliance;

FIG. 2 is a schematic diagram of primary coils arranged in the contactless power supply device;

FIGS. 3A and 3B are a cross-sectional view and a plan view of a primary coil wound around a magnetic body;

FIGS. 4A and 4B are a cross-sectional view and a bottom view of a secondary coil wound around a magnetic body;

FIGS. 5A and 5B are a plan view and a schematic cross-sectional view of the secondary coil and two primary coils;

FIGS. 6A and 6B are a plan view and a schematic cross-sectional view of the secondary coil and four primary coils;

FIG. 7 is a graph showing the output of the secondary coil in the contactless power supply system of the embodiment;

FIG. 8 is a graph showing the output of a secondary coil in a contactless power supply system of example 1;

FIG. 9 is a graph showing the output of a secondary coil in a contactless power supply system of example 2;

FIG. 10 is a graph showing the output of a secondary coil in a contactless power supply system of example 3;

FIG. 11 is a graph showing the output of a secondary coil in a contactless power supply system of example 4;

FIG. 12 is a graph showing the output of a secondary coil in a contactless power supply system of example 5;

FIG. 13 is a graph showing the output of a secondary coil in a contactless power supply system of example 6;

FIG. 14 is a graph showing the voltage conversion rate of the secondary coil in the contactless power supply system of various examples;

FIGS. 15A and 15B are perspective views of the primary coils and the secondary coil in a first referential example;

FIGS. 16A and 16B are perspective views of the primary coils and the secondary coil in the first referential example;

FIG. 17 is a graph showing the output of the secondary coil in the first referential example;

FIGS. 18A and 18B are perspective views of the primary coils and the secondary coil in a second referential example;

FIGS. 19A and 19B are perspective views of the primary coils and the secondary coil in the second referential example; and

FIG. 20 is a graph showing the output of the secondary coils in the second referential example.

### EMBODIMENTS OF THE INVENTION

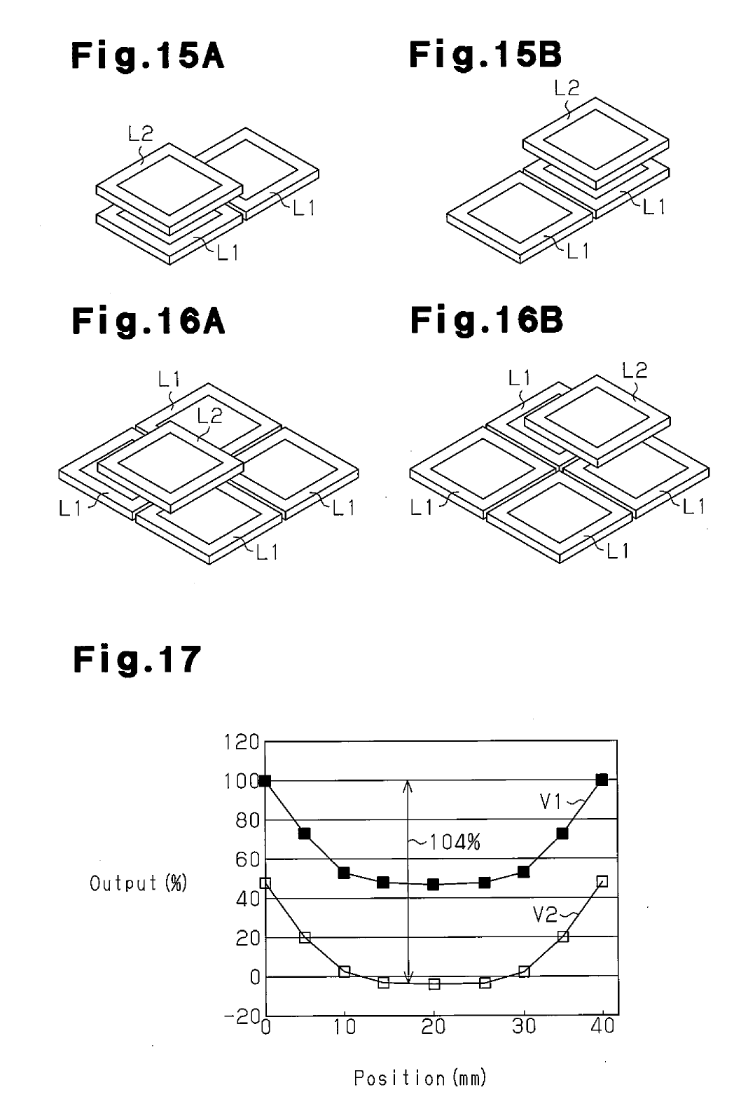

Referential examples that were contemplated by the inventors of the present invention will now be discussed with reference to FIGS. 15 to 20 before describing embodiments.

FIGS. 15A and 15B schematically illustrates part of a contactless power supply system in a first referential example. A secondary coil L2 was arranged above two primary coils L1, which were arranged along a single line. The primary coils L1 and the secondary coil L2 had the same tetragonal shape. FIG. 15A illustrates the secondary coil L2 arranged at a position directly opposed to one of the primary coils L1. FIG. 15B illustrates the secondary coil L2 arranged at a position directly opposed to the other one of the primary coils L1. In a state in which the two primary coils L1 were excited, the present inventors of the present invention measured the output of the secondary coil L2 at various positions above the primary coils L1 within the range from the position illustrated in FIG. 15A to the position illustrated in FIG. 15B. The results are shown by the characteristic line V1 in FIG. 17.

The vertical axis of FIG. 17 indicates the output (%) of the secondary coil L2. When the output of the secondary coil L2 is 100%, this indicates that the secondary coil L2 has received 100% of the output voltage of the primary coil L1. As apparent from the characteristic line V1 in FIG. 17, when the secondary coil L2 was directly opposed to one of the primary coils L1, the secondary power of the secondary coil L2 was 100%. The power reception efficiency decreased when the secondary coil L2 was located at a position other than where it is directly opposed to a primary coil L1. When the secondary coil L2 was arranged at a halfway position between the two primary coils L1, the power reception efficiency became minimal.

FIGS. 16A and 16B schematically show another part of the contactless power supply system in the first referential example. The secondary coil L2 was arranged above four primary coils L1 arranged in a two by two matrix. FIG. 16A illustrates a secondary coil L2 arranged at a position located between the two front primary coils L1, and FIG. 16B illustrates the secondary coil L2 arranged at a position located between the two rear primary coils L1. In a state in which the four primary coils L1 were excited, the inventors of the present invention measured the output of the secondary coil L2 at various positions above the primary coils L1 within the range from the position shown in FIG. 16A to the position shown in FIG. 16B. The results are shown by the characteristic line V2 in FIG. 17.

As apparent from the characteristic line V2 in FIG. 17, when the secondary coil L2 was not located at the position of FIG. 16A or the position of FIG. 16B, the power reception efficiency of the secondary coil L2 was significantly low. In particular, when the secondary coil L2 was arranged near a halfway position between the position of FIG. 16A and the position of FIG. 16B, the secondary power of the secondary coil L2 became zero. Accordingly, depending on the position of an electric appliance, the supply of power from a contactless power supply device to a power reception device of the electric appliance may be stopped.

In addition, in the first referential example, the output voltage variation rate was 104% and extremely high. Thus, a large difference was produced in the power supply rate depending on the position at which the electric appliance was set.

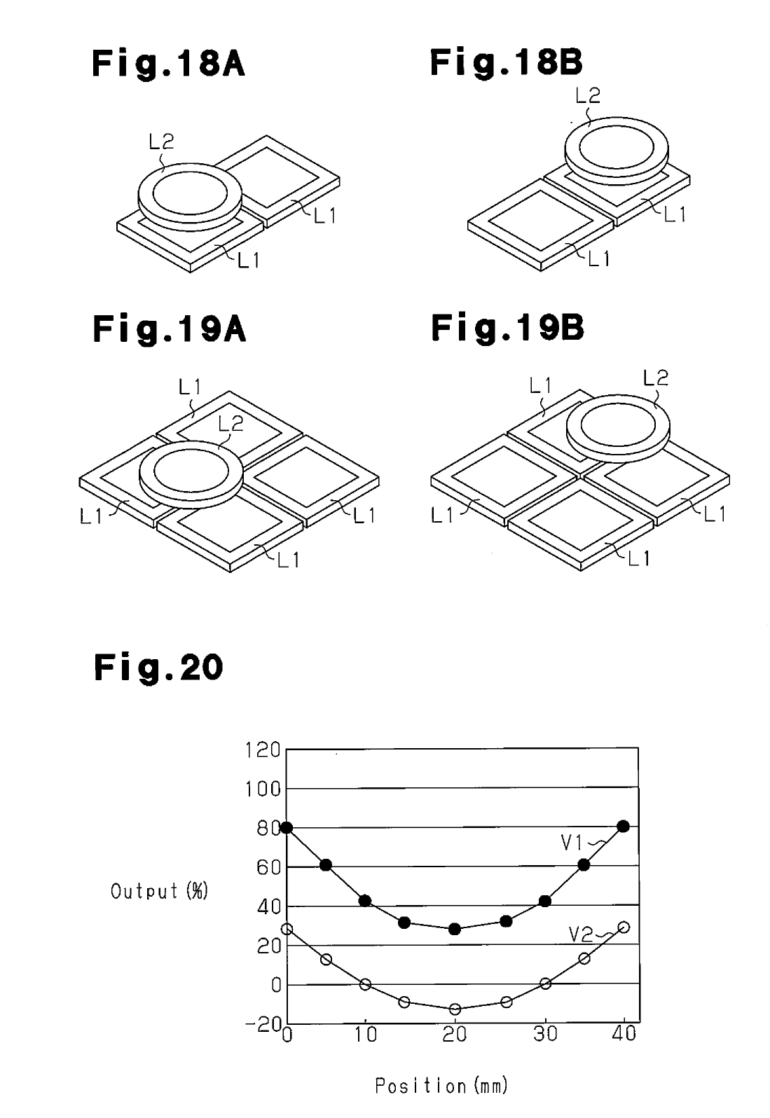

FIGS. 18A and 18B and FIGS. 19A and 19B show part of a contactless power supply system in a second referential example. In the second referential example, the tetragonal secondary coil L2 of the first referential example was replaced by a circular secondary coil L2. The circular secondary coil L2 had a diameter that was the same as the length of each side of the square primary coil L1.

In the same manner as the first referential example, the output of the secondary coil L2 was measured at various positions above the primary coils L1 within the range from the position shown in FIG. 18A to the position shown in FIG. 18B. The results are shown by the characteristic line V1 in FIG. 20. As apparent from the characteristic line V1 in FIG. 20, when the circular secondary coil L2 was directly opposed to one of the primary coils L1, the secondary power of the secondary coil L2 was 80%. The power reception efficiency decreased when the secondary coil L2 was not located at a position directly opposing a primary coil L1. When the secondary coil L2 was arranged at a halfway position between the front and rear primary coils L1, the power reception efficiency became minimal.

Further, in the same manner as the first referential example, the output of the secondary coil L2 was measured at various positions above the primary coils L1 within the range from the position shown in FIG. 19A to the position shown in FIG. 19B. The results are shown by the characteristic line V2 in FIG. 20. As apparent from the characteristic line V2 in FIG. 20, when the circular secondary coil L2 was located at a position other than the positions of FIGS. 19A and 19B, the secondary power of the secondary coil L2 was significantly low. In particular, when the secondary coil L2 was arranged near a halfway position between the position of FIG. 19A and the position of FIG. 19B, the secondary power of the secondary coil L2 was zero. Accordingly, depending on the position of an electric appliance, the supply of power from a contactless power supply device to a power reception device of the electric appliance may also be stopped in the second referential example.

A contactless power supply system according to one embodiment of the present invention will now be described.

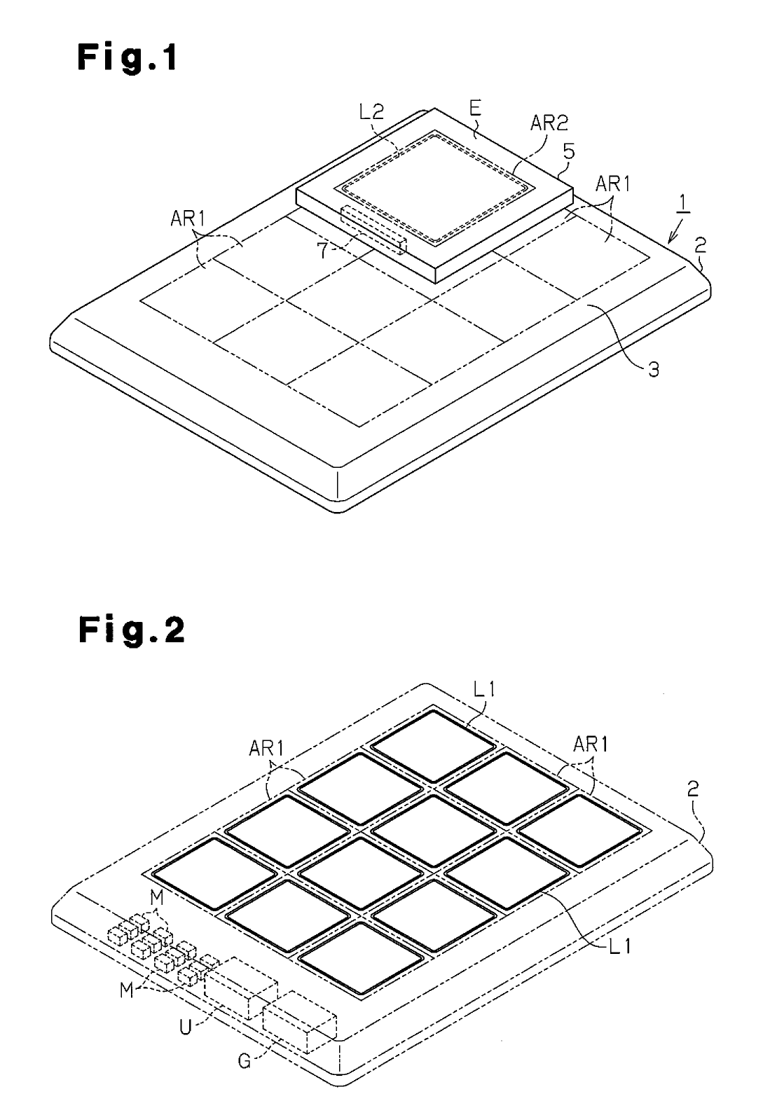

As illustrated in FIG. 1, the contactless power supply system includes a contactless power supply device (hereinafter, simply referred to as the power supply device) 1 and an electric appliance E, which is supplied with power in a contactless manner.

The power supply device 1 includes a tetragonal and planar frame 2. The frame 2 includes a flat upper surface that defines a setting surface 3 on which the electric appliance E is set. The setting surface 3 includes a plurality of tetragonal power supply areas AR1. The power supply areas AR1 of the setting surface 3 are in a three by four matrix in the present embodiment.

As illustrated in FIG. 2, in the frame 2, a primary coil L1 is arranged at a location corresponding to each power supply area AR1 and wound into a tetragonal shape in conformance with the contour of the power supply area AR1.

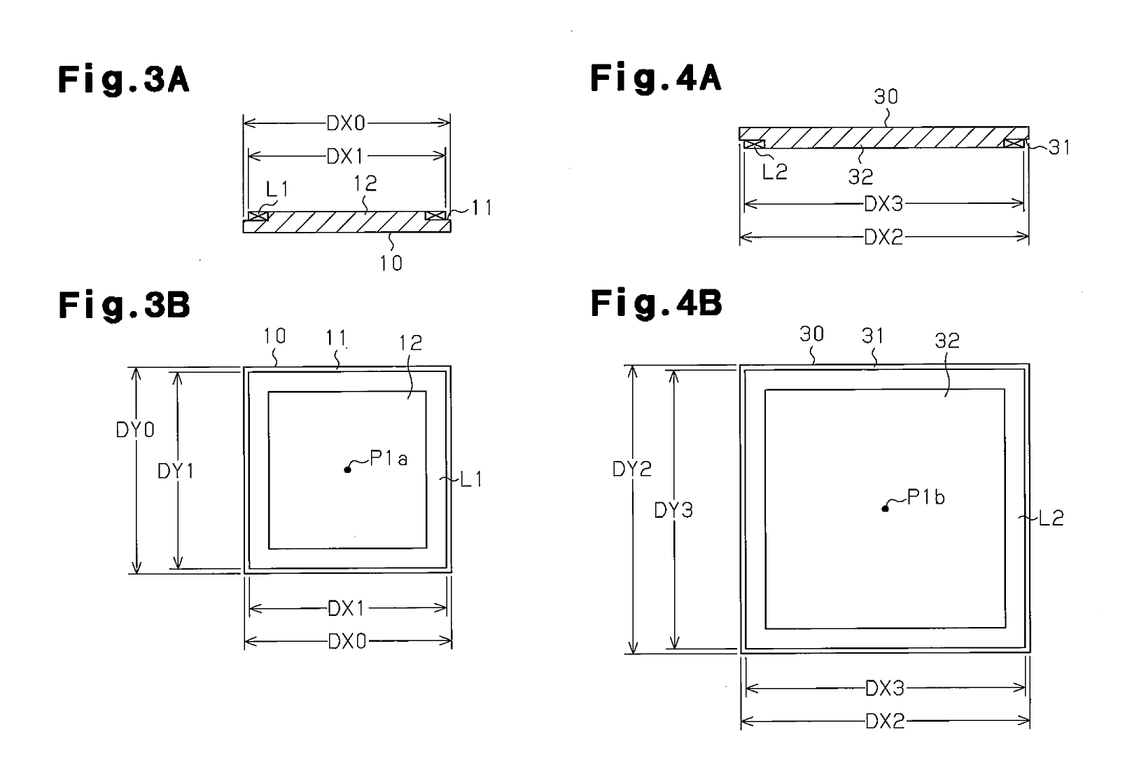

As illustrated in FIGS. 3A and 3B, each primary coil L1 is wound around a tetragonal and planar magnetic body 10, which is formed from a soft magnetic material (soft ferrite). In one example, the magnetic body 10 is square and its sides have lengths DX0 and DY0 that are 42 mm. The magnetic body 10 includes a tetragonal core 12 and a rim 11, which surrounds the core 12.

The primary coil L1, which is wound around the core 12 of the magnetic body 10, is square as viewed from above. In one example, the primary coil L1 has a square contour and its sides have lengths DX1 and DY1 that are 40 mm. The magnetic body 10, which has the primary coil L1 wound around the core 12, is fixed at a position corresponding to each power supply area AR1 in the frame 2.

In the present embodiment, the magnetic bodies 10, around which the primary coils L1 are wound, are fixed at predetermined intervals (approximately one millimeter) from the adjacent magnetic body 10.

As illustrated in FIG. 2, the frame 2 accommodates, at locations other than the power supply areas AR1, power supply unit circuits M, which are provided for each of the power supply areas AR1, a power circuit G, which supplies power to each power supply unit circuit M, and a common unit circuit U, which centrally controls the power supply unit circuits M.

The power supply unit circuits M cooperate with solely the corresponding primary coil L1 or with other primary coils L1 to supply power in a contactless manner to the electric appliance E set on the corresponding power supply area AR1.

As illustrated in FIG. 1, the electric appliance E includes a frame 5 having a lower surface that forms a power reception area AR2. The frame 5 accommodates a secondary coil L2.

As illustrated in FIGS. 4A and 4B, the secondary coil L2 is wound around a tetragonal and planar magnetic body 30, which is formed from a soft magnetic material (soft ferrite). In one example, the magnetic body 30 is square and its sides have lengths DX2 and DY2 that are 58 mm. The magnetic body 30 includes a tetragonal core 32 and a rim 31, which surrounds the core 32.

The secondary coil L2 is wound around the core 32 of the magnetic body 30. The secondary coil L2, which is wound around the core 32 of the magnetic body 30, is square as viewed from below. In one example, the secondary coil L2 has a square contour and its sides have lengths DX3 and DY3 that are 56 mm. The secondary coil L2 is fixed, together with the magnetic body 30, in the frame 2 at the power supply area AR2.

When the electric appliance E is set on the setting surface 3 of the power supply device 1, the primary coil L1 of the power supply area AR1 located immediately below the electric appliance E is excited. Further, the secondary coil L2 in the electric appliance E receives secondary power through electromagnetic induction. The secondary power of the secondary coil L2 is affected by the magnetic coupling of the primary coil L1 and the secondary coil L2. Like in the referential example, when the secondary coil L2 is directly opposed to a single primary coil L1, the secondary coil L2 receives the maximum secondary power. When the secondary coil L2 is not directly opposed to a primary coil L1, interference with the magnetic flux of the adjacent primary coil L1 changes the secondary power received by the secondary coil L2.

The secondary power received by the secondary coil L2 is rectified by a rectification circuit arranged in a power reception device 7, which is located in the frame 5 at a position adjacent to the secondary coil L2, converted by a DC/DC converter to the desired DC voltage, and supplied to a load of the electric device E.

The operation of the non-contact power supply system will now be described.

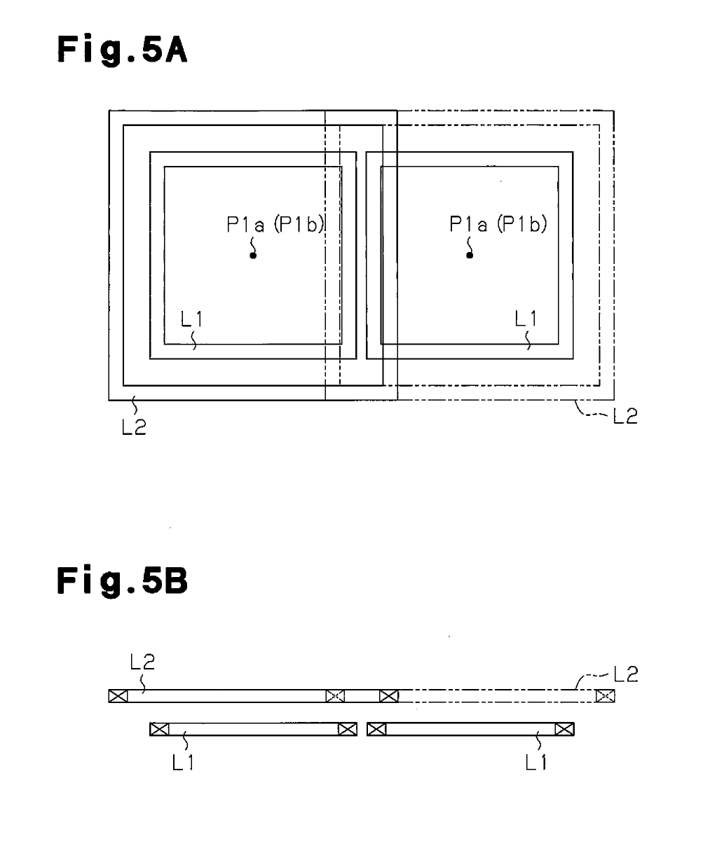

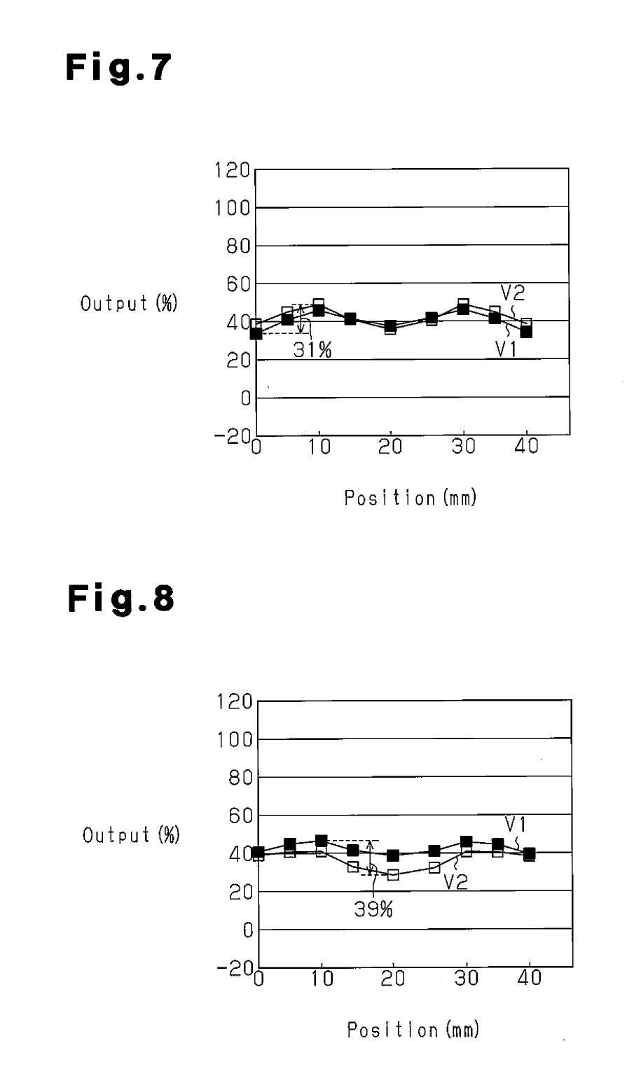

FIGS. 5A and 5B schematically show part of the contactless power supply system of FIG. 1. The relatively large secondary coil L2 is arranged above two relatively small primary coils L1, which are arranged in a single line. In a state in which the two primary coils L1 were excited, the output of the secondary coil L2 was measured at various positions in a range from a directly opposed position where a center point P1b of the secondary coil L2 is aligned with a center point P1a of the left primary coil L1 to a directly opposed position where the center point P1b is aligned with a center point P1a of the right primary coil L1. The results are shown by the characteristic line V1 in FIG. 7.

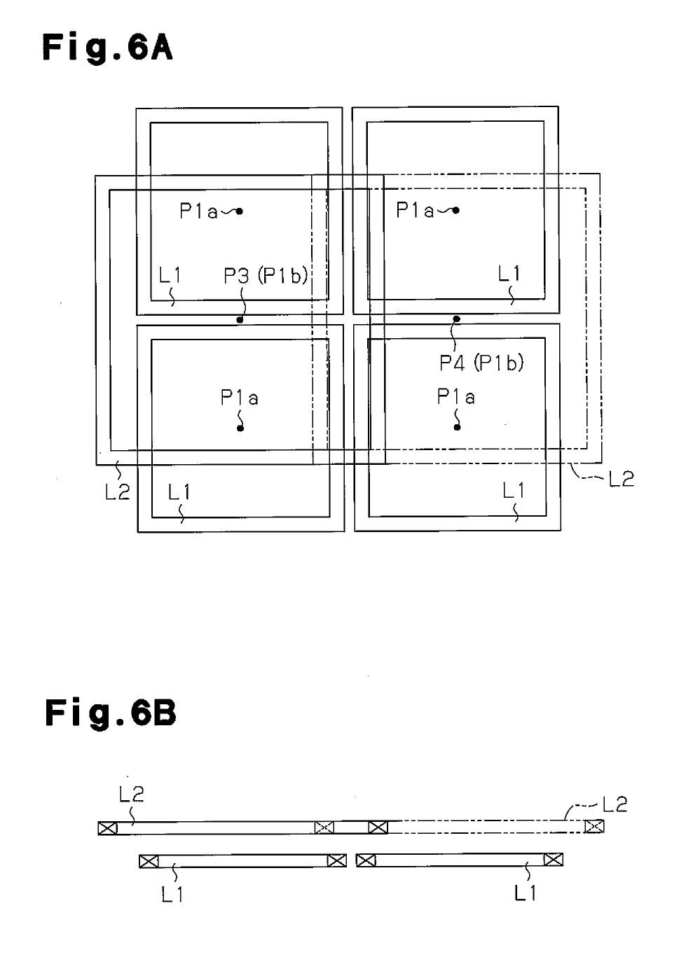

FIGS. 6A and 6B schematically show part of the contactless power supply system of FIG. 1. The relatively large secondary coil L2 is arranged above four relatively small primary coils L1, which are arranged in a two by two matrix. In a state in which the four primary coils L1 were excited, the output of the secondary coil L2 was measured at various positions in a range from the position where a center point P1b of the secondary coil L2 is aligned with median point P3 of the two primary coils L1 located at the left side to the position where the center point P1b is aligned with a median point P4 of the two primary coils L1 located at the right side. The results are shown by the characteristic line V2 in FIG. 7.

As apparent from the characteristic lines V1 and V2 of FIG. 7, in the contactless power supply system of FIG. 1, the output voltage variation rate, which indicates the difference between when the output of the secondary coil L2 is minimal and maximal, was 31% and significantly low.

Further, regardless of where the electric appliance E is arranged on the setting surface 3, power is supplied with a power supply efficiency that has a small difference in which the output is centered on approximately 40%. Unlike the referential example, there were no positions where the secondary power of the secondary coil L2 was zero. Accordingly, in this embodiment, regardless of where the electric device E is located, the supply of power to the power reception device of the electric device from the contactless power supply device is never stopped.

### Example 1

In example 1, 40 mm×40 mm primary coils L1 and a 54 mm×54 mm secondary coil L2 was used. The output of the secondary coil L2 was measured at various positions in a range from the position shown by solid lines in FIG. 5 to the position shown by double-dashed lines in FIG. 5. The results are shown by the characteristic line V1 in FIG. 8.

Further, the output of the secondary coil L2 was measured at various positions in a range from the position shown by solid lines in FIG. 6 to the position shown by double-dashed lines in FIG. 6. The results are shown by the characteristic line V2 in FIG. 8.

As apparent from the characteristic lines V1 and V2 in FIG. 8, there was no position on the setting surface 3 where the electric appliance E was set at which the secondary power of the secondary coil L2 became zero. Further, the output voltage variation rate was 39%.

### Example 2

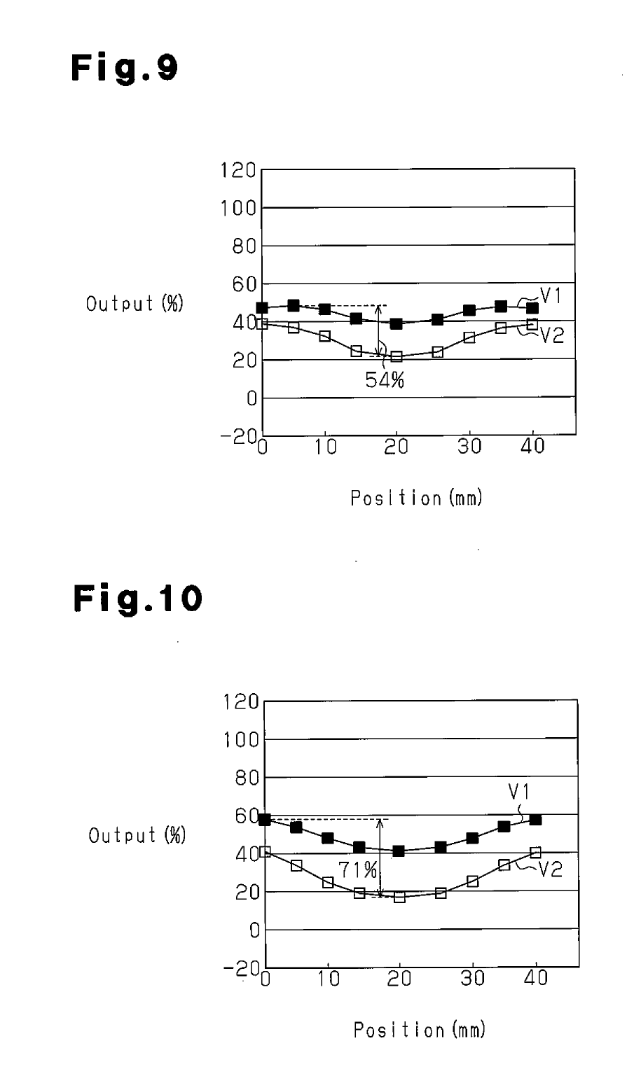

In example 2, 40 mm×40 mm primary coils L1 and a 52 mm×52 mm secondary coil L2 was used. The output of the secondary coil L2 was measured at various positions in a range from the position shown by the solid lines in FIG. 5 to the position shown by the double-dashed lines in FIG. 5. The results are shown by the characteristic line V1 in FIG. 9.

Further, the output of the secondary coil L2 was measured at various positions in a range from the position shown by the solid lines in FIG. 6 to the position shown by the double-dashed lines in FIG. 6. The results are shown by the characteristic line V2 in FIG. 9.

As apparent from the characteristic lines V1 and V2 in FIG. 9, there was no position on the setting surface 3 where the electric appliance E was set at which the secondary power of the secondary coil L2 became zero. Further, the output voltage variation rate was 54%.

### Example 3

In example 3, 40 mm×40 mm primary coils L1 and a 50 mm×50 mm secondary coil L2 was used. The output of the secondary coil L2 was measured at various positions in a range from the position shown by the solid lines in FIG. 5 to the position shown by the double-dashed lines in FIG. 5. The results are shown by the characteristic line V1 in FIG. 10.

Further, the output of the secondary coil L2 was measured at various positions in a range from the position shown by the solid lines in FIG. 6 to the position shown by the double-dashed lines in FIG. 6. The results are shown by the characteristic line V2 in FIG. 10.

As apparent from the characteristic lines V1 and V2 in FIG. 10, there was no position on the setting surface 3 where the electric appliance E is set at which the secondary power of the secondary coil L2 became zero. Further, the output voltage variation rate was 71%.

### Example 4

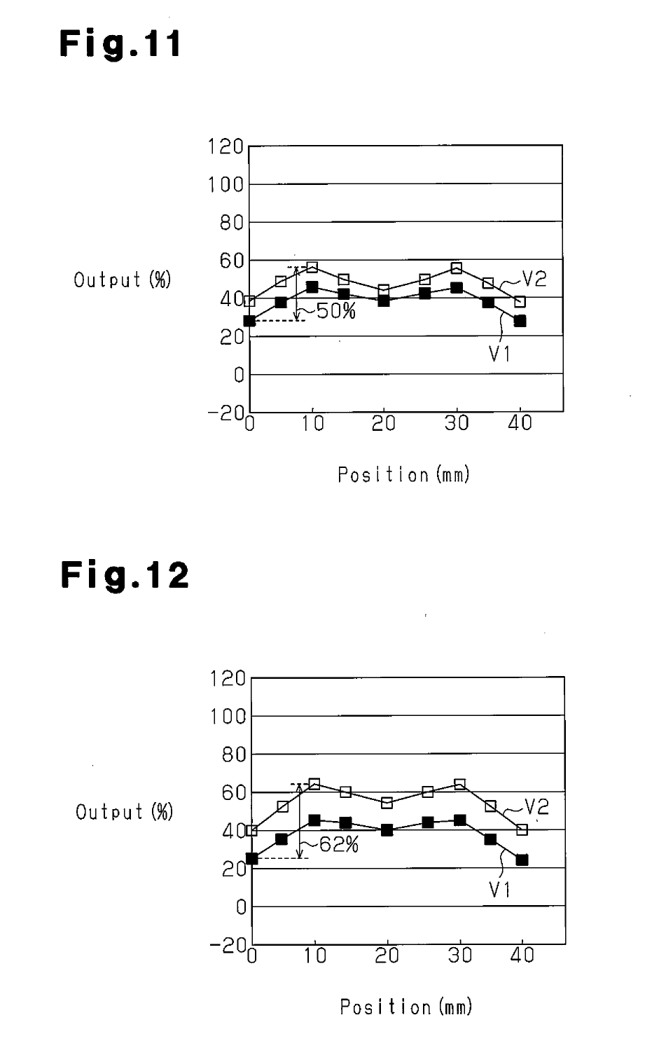

In example 4, 40 mm×40 mm primary coils L1 and a 58 mm×58 mm secondary coil L2 was used. The output of the secondary coil L2 was measured at various positions in a range from the position shown by the solid lines in FIG. 5 to the position shown by the double-dashed lines in FIG. 5. The results are shown by the characteristic line V1 in FIG. 11.

Further, the output of the secondary coil L2 was measured at various positions in a range from the position shown by the solid lines in FIG. 6 to the position shown by the double-dashed lines in FIG. 6. The results are shown by the characteristic line V2 in FIG. 11.

As apparent from the characteristic lines V1 and V2 in FIG. 11, there was no position on the setting surface 3 where the electric appliance E was set at which the secondary power of the secondary coil L2 became zero. Further, the output voltage variation rate was 50%.

### Example 5

In example 5, 40 mm×40 mm primary coils L1 and a 60 mm×60 mm secondary coil L2 was used. The output of the secondary coil L2 was measured at various positions in a range from the position shown by the solid lines in FIG. 5 to the position shown by the double-dashed lines in FIG. 5. The results are shown by the characteristic line V1 in FIG. 12.

Further, the output of the secondary coil L2 was measured at various positions in a range from the position shown by the solid lines in FIG. 6 to the position shown by the double-dashed lines in FIG. 6. The results are shown by the characteristic line V2 in FIG. 12.

As apparent from the characteristic lines V1 and V2 in FIG. 12, there was no position on the setting surface 3 where the electric appliance E was set at which the secondary power of the secondary coil L2 became zero. Further, the output voltage variation rate was 62%.

### Example 6

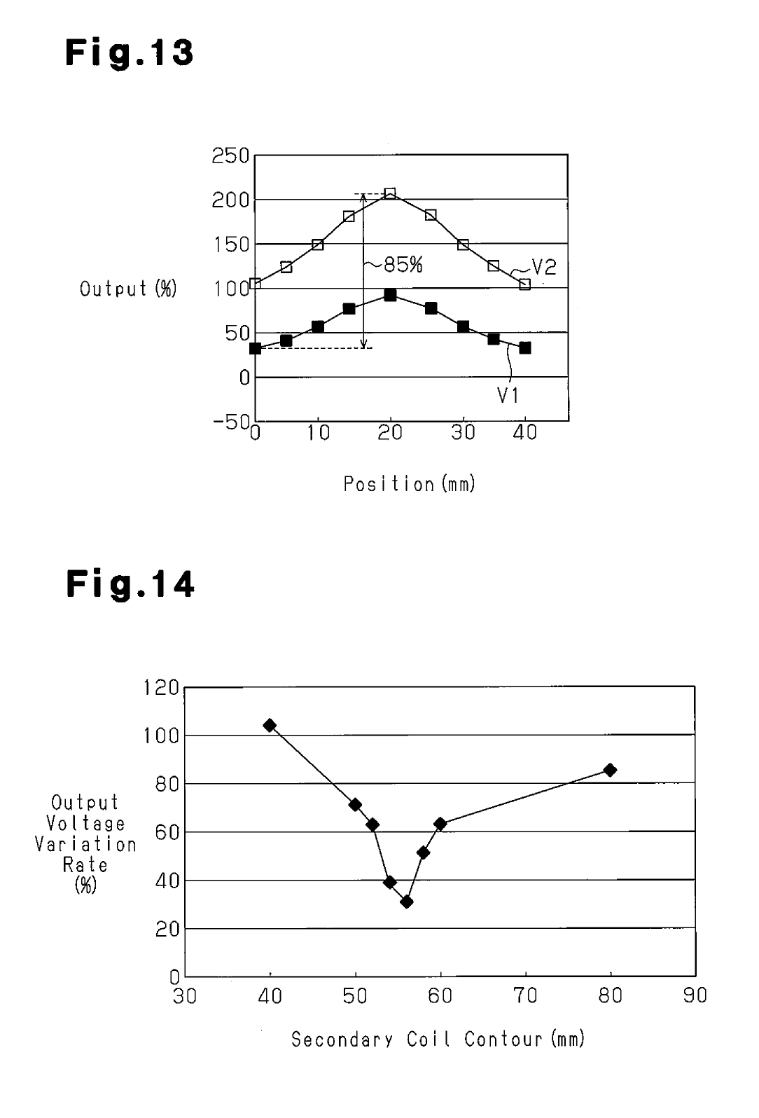

In example 6, 40 mm×40 mm primary coils L1 and an 80 mm×80 mm secondary coil L2 was used. The output of the secondary coil L2 was measured at various positions in a range from the position shown by the solid lines in FIG. 5 to the position shown by the double-dashed lines in FIG. 5. The results are shown by the characteristic line V1 in FIG. 13.

Further, the output of the secondary coil L2 was measured at various positions in a range from the position shown by the solid lines in FIG. 6 to the position shown by the double-dashed lines in FIG. 6. The results are shown by the characteristic line V2 in FIG. 13.

As apparent from the characteristic lines V1 and V2 in FIG. 13, there was no position on the setting surface 3 where the electric appliance E was set at which the secondary power of the secondary coil L2 became zero. Further, the output voltage variation rate was 85%.

FIG. 14 shows the output conversion rates (%) of various examples including examples 1 to 6 that use the 40 mm×40 mm primary coil L1 and the various 40 mm×40 mm to 80 mm×80 mm secondary coils L2.

The following is apparent from FIGS. 8 to 14.

(1) When using a secondary coil L2 with a coil contour of 56 mm×56 mm for the 40 mm×40 mm primary coils L1, the output voltage variation rate is 31%, which is the minimum output voltage variation rate. In other words, when the coil contour of the secondary coil L2 is 1.4 times larger than the coil contour of the primary coil L1, the output voltage variation rate is minimal.

(2) When using a secondary coil L2 with a coil contour in the range of 50 mm×50 mm to 80 mm×80 mm, the secondary power of the secondary coil L2 does not become zero regardless of where the secondary coil L2 is arranged on the setting surface 3. In other words, as long as the coil contour of the secondary coil L2 is 1.25 to 2.0 times larger that the coil contour of the primary coil L1, the secondary power of the secondary coil L2 does not become zero.

(3) When using the 40 mm×40 mm primary coil L1 and the 56 mm×56 mm secondary coil L2 as a reference, the output voltage variation rate increases as the coil contour of the secondary coil L2 becomes closer to the coil contour of the 40 mm×40 mm primary coil L1. In other words, the output voltage variation rate increases as the coil contour of the secondary coil L2 becomes smaller than 1.4 times the coil contour of the primary coil L1.

From the viewpoint of practicability, when the coil contour of the secondary coil L2 is reduced from 1.4 times, it is preferred that the output voltage variation rate be substantially 70% at maximum regardless of where the secondary coil L2 is arranged on the setting surface 3 (power supply area AR1). Accordingly, as apparent from FIG. 14, the coil contour of the secondary coil L2 can be reduced to 50 mm×50 mm. That is, it is preferred that the coil contour of the secondary coil L2 be 1.25 times or larger than the coil contour of the secondary coil L2.

Further, when the coil profile of the secondary coil L2 is reduced to 52 mm×52 mm, it is preferred that the output voltage variation rate be 54% or less. That is, it is further preferred that the coil contour of the secondary coil L2 be 1.3 times or larger than the coil contour of the primary coil L1.

(4) When using the 40 mm×40 mm primary coil L1 and the 56 mm×56 mm secondary coil L2 as a reference, the output voltage variation rate increases as the coil contour of the secondary coil L2 becomes larger.

In other words, when using a secondary coil L2 that is 1.4 times larger than the coil contour of the primary coil L1 as a reference, the output voltage variation rate increases as the coil contour of the secondary coil L2 becomes larger than 1.4 times.

From the viewpoint of practicability, when the coil contour of the secondary coil L2 is enlarged from 1.4 times, it is preferred that the output voltage variation rate be substantially 70% at maximum regardless of where the secondary coil L2 is arranged on the setting surface 3 (power supply area AR1). Accordingly, as apparent from FIG. 14, the coil contour of the secondary coil L2 can be enlarged to 68 mm×68 mm. That is, it is preferred that the coil contour of the secondary coil L2 be 1.7 times or smaller than the coil contour of the secondary coil L2.

As can be understood from the above, when the coil contour of the secondary coil L2 is set to be 1.25 to 1.7 times larger than the coil contour of the primary coil L1, the output voltage variation rate is substantially 50% and becomes further practical.

The above embodiment has the advantages described below.

(1) In the above embodiment, the coil contour of the secondary coil L2 in the electric appliance E is larger than the coil contour of the primary coils L1 in the power supply device 1. Thus, the secondary power received by the secondary coil L2 does not become zero regardless of where the electric appliance E is set on the setting surface 3.

(2) In the above embodiment, the coil contour of the secondary coil L2 is set to be 1.25 times or larger and 1.7 times or smaller than the coil contour of the primary coil L1. As a result, the output voltage variation rate is 70% or less, and a preferred output voltage variation rate can be obtained.

(3) In the preferred embodiment, the coil contour of the secondary coil L2 is set to be 1.3 times or larger and 1.45 times or smaller than the coil contour of the primary coil L1. As a result, the output voltage variation rate is 50% or less, and a further preferred output voltage variation rate can be obtained.

(4) In the preferred embodiment, the coil contour of the secondary coil L2 of the electric appliance E is set to be 1.4 times larger than the coil contour of the primary coil L1. As a result, the output voltage variation rate is 31%. Accordingly, changes can be decreased in the secondary power received by the secondary coil L2 regardless of where the electric appliance E is set on the setting surface 3. That is, the bias in the secondary power received by the secondary coil L2, which results from where the electric appliance E is set on the setting surface 3, can be significantly decreased. Consequently, the electric appliance E can be set at any position on the setting surface 3 without the need to worry where it should be set.

(5) In the present embodiment, the primary coils L1 are tetragonal. The tetragonal primary coils L1 eliminate locations unreached by the exciting magnetic flux of the primary coils L1 and increase the power supplying efficiency.

The above embodiment may be modified as described below.

In the above embodiment, the primary coils L1 have a coil contour of 40 mm×40 mm but are not limited to such dimensions and may be changed as required. In this case, the coil contour of the secondary coil L2 must be changed relative to the change in the coil contour of the primary coil L1.

In the above embodiment, the primary coil L1 and the secondary coil L2 are respectively wound around the magnetic bodies 10 and 30 to increase the magnetic flux. However, the magnetic bodies 10 and 30 may be omitted.

In the above embodiment, the primary coils L1 are square. However, rectangular or hexagonal primary coils may be used instead. This also eliminates locations unreached by the exciting magnetic flux in the rectangular or hexagonal power supply areas. In this case, the coil contour of the secondary coil L2 is similar to the primary coil L1 and must be changed at the same rate relative to the change in the coil contour of the primary coil L1.

In the above embodiment, adjacent primary coils L1 around which the primary coils L1 are wound are spaced apart by an interval (one millimeter). However, this may be changed as required. Obviously, the magnetic bodies 10 may be arranged in contact with one another.

In the above embodiment, twelve power supply areas AR1 are formed. However, there is no such limitation and this may be changed as required.

The embodiments of the present invention have been described with reference to the drawings. However, the present invention is not to be limited to above description and may be modified within the scope and equivalence of the appended claims.

1. A contactless power supply system comprising:
an electric appliance including a secondary coil of a power reception device; and
a contactless power supply device including a setting surface, which is formed by a plurality of adjacent power supply areas, and a primary coil, which is arranged in each power supply area, wherein the contactless power supply device excites the primary coil to supply secondary power to the secondary coil of the electric appliance that is set on the setting surface,
wherein the secondary coil has a larger coil contour than the primary coil.

2. The contactless power supply system according to claim 1, wherein the coil contour of the secondary coil is 1.25 times or larger and 1.7 times or smaller than the coil contour of the primary coil.

3. The contactless power supply system according to claim 2, wherein the coil contour of the secondary coil is 1.3 times or larger and 1.45 times or smaller than the coil contour of the primary coil.

4. The contactless power supply system according to claim 3, wherein the coil contour of the secondary coil is 1.4 times larger than the coil contour of the primary coil.

5. The contactless power supply system according to claim 1, wherein
each primary coil is tetragonal and shaped in conformance with the corresponding power supply area, and
the secondary coil is tetragonal and similar to the coil contour of the primary coil.

6. The contactless power supply system according to claim 1, wherein the primary coil and the secondary coil are each wound around a magnetic body.

7. A power reception device arranged in an electric appliance and used with a contactless power supply device including a setting surface, which is formed by a plurality of adjacent power supply areas, and a primary coil, which is arranged in each power supply area, the power reception device comprising
a secondary coil that receives secondary power from the primary coil that is excited,
wherein the secondary coil has a larger coil contour than the primary coil.

8. The power reception device according to claim 7, wherein the coil contour of the secondary coil is 1.25 times or larger and 1.7 times or smaller than the coil contour of the primary coil.

9. The power reception device according to claim 8, wherein the coil contour of the secondary coil is 1.3 times or larger and 1.45 times or smaller than the coil contour of the primary coil.

10. The power reception device according to claim 9, wherein the coil contour of the secondary coil is 1.4 times larger than the coil contour of the primary coil.

11. The power reception device according to claim 7, wherein the secondary coil is tetragonal and similar to the coil contour of the primary coil.

12. The power reception device according to claim 7, wherein the secondary coil is wound around a magnetic body.
